(19) United States
(12) Patent Application Publication
(10) Pub. No.: US 2017/0313047 A1
(43) Pub. Date: Nov. 2, 2017

(54) 3D JET PRINTING APPARATUS HAVING RECIPROCATING JETTING MOLDING MECHANISM

(71) Applicant: METAL INDUSTRIES RESEARCH & DEVELOPMENT CENTRE, Kaohsiung (TW)

(72) Inventors: Shin-Hong KUO, Kaohsiung (TW); Cheng-Bo WU, Kaohsiung (TW); Ching-Tsai WU, Kaohsiung (TW)

(73) Assignee: Metal Industries Research & Development Centre

(21) Appl. No.: 15/281,819

(22) Filed: Sep. 30, 2016

(30) Foreign Application Priority Data
Apr. 29, 2016 (TW) 105113537

(51) Int. Cl. B33Y 30/00

(52) U.S. Cl. CPC B33Y 30/00

(57) ABSTRACT

A 3D jet printing apparatus having a reciprocating jetting molding mechanism includes: a molding platform mechanism, a jet printing mechanism, and a vertical lifting mechanism; where the molding platform mechanism has a molding area plane; the jet printing mechanism is provided above the molding platform, and can correspondingly perform reciprocating movement of forward and reverse strokes; the jet printing mechanism includes a powder spreading unit, powder supply units, and jet printing units; the powder supply units can drop a powder material to the molding area plane; the powder spreading unit then spreads flat the powder material on the molding area plane, and subsequently the jet printing units perform binder jet printing on the powder material that is spread flat; and after the jet printing mechanism performs a stroke once, the vertical lifting mechanism adds a vertical stacking distance between the jet printing mechanism and the molding platform mechanism.

### CROSS-REFERENCE TO RELATED APPLICATION

This application claims the benefit of Taiwan Patent Application No. 105113537, filed on Apr. 29, 2016, which is hereby incorporated by reference for all purposes as if fully set forth herein.

### BACKGROUND

### Technical Field

The present disclosure relates to a three-dimensional (3D) printing apparatus for performing an additive molding method by using powder materials in cooperation with binders, and more specifically, to a fast 3D jet printing apparatus having a reciprocating jetting molding mechanism.

### Related Art

According to a definition, which is made by American Society for Testing and Materials (ASTM), of “Additive Manufacturing (AM)”, also called “3D printing”, the AM is a process of material process bonding; the technology processes 3D model data by using computer-aided design (CAD) and stacks materials layer by layer to produce 3D objects; the additive process is different from a conventional subtractive manufacturing manner (for example, metal cutting processing). The “AM” can stack powder-shaped or liquid-state raw materials into 3D physical objects, so as to greatly reduce various technical difficulties for manufacturing objects in the past; with the help of the CAD, a possibility of individualization and specialization of the manufactured objects is greatly improved. It can be said that the invention and development of the AM open an era of guiding a production mode of the manufacturing industry towards customized production that satisfies personal requirements.

The ASTM subdivides the AM into seven categories, including a polymeric material stereolithograghy technology, a material jetting molding technology, a binder jetting molding technology, a thermoplastic extrusion molding technology, a powder bed melting molding technology, a lamination manufacturing molding technology, and a direct energy deposition technology; the technologies that are currently applied most widely are the “thermoplastic extrusion molding technology”, the “polymeric material stereolithograghy technology”, and the “powder bed melting molding technology”.

As shown in FIG. 1A, the American patent case US54863538A is a basis of an additive molding technology by using selective laser sintering (SLS) 10 in a 3D printing method; in the patent case, an apparatus is used to spread powder 11 on a substrate 12, and then an illumination range of an energy light beam 13 is coated and planned by using a specific section profile of an object to be manufactured; the illumination range is illuminated by using the energy light beam 13 to sinter the powder; after the foregoing the steps are repeated, the object to be manufactured is established by sintering a material of the powder to make the material of the powder molded in a manner of stacking sections of the object layer by layer.

In addition, the foregoing additive molding technology 15 by using powder in cooperation with binders is a technology of jetting powder by using binders (BJ, Binder Jetting) to make the powder hardened and molded; a technology of a molding platform 16 and powder supply units 17 thereof is similar to the foregoing SLS, and a difference therebetween lies in that a needed product is produced by powder sintering/melting by using laser/electronic beam thermal energy, and BJ is to jet print binders, by using a jet printing head 18, on powder to make the powder hardened and molded. However, according to a structural design of the current BJ molding technology, the structure can perform merely work of one-way additive jet printing, and therefore a molding speed is slow, and jet printing and molding on different materials cannot be implemented.

### SUMMARY

An objective of the present disclosure lies in providing a 3D printing apparatus for performing an additive molding method by using powder materials in cooperation with binders, and by changing configurations of powder supply units, a powder spreading unit, and an adhesive coating unit, enabling a horizontal moving mechanism to perform printing when the horizontal moving mechanism performs movement in any direction of reciprocating directions.

To achieve the foregoing objective, the present disclosure provides a 3D jet printing apparatus having a reciprocating jetting molding mechanism, where the 3D jet printing apparatus having a reciprocating jetting molding mechanism includes a molding platform mechanism, a jet printing mechanism, and a vertical lifting mechanism. The molding platform mechanism includes a molding area plane, where the molding area plane has a working direction; the jet printing mechanism is provided above the molding platform and can be enabled to perform reciprocating movement of forward and reverse strokes along a path of the working direction; the jet printing mechanism includes a powder spreading unit, powder supply units, and jet printing units; the powder supply units can drop a powder material to the molding area plane; the powder spreading unit immediately spreads flat the powder material on the molding area plane to form a powder material layer in a heading direction process; the jet printing units perform binder jet printing on the powder material layer that is spread flat; and the vertical lifting mechanism is connected to the molding platform mechanism or the jet printing mechanism, and enables the jet printing mechanism and the molding platform mechanism to change a distance therebetween according to occasions of requirements.

In an embodiment, the molding platform mechanism of the present disclosure includes a lifting platform; the vertical lifting mechanism is connected to the lifting platform, and a location of the molding area plane is an upper surface of the lifting platform or an upper surface of the powder material layer that is spread flat on the lifting platform.

In an embodiment, the molding area plane includes a wide edge in a direction vertical to the working direction; the powder supply units of the jet printing mechanism include a powder supply outlet and a powder groove connected to the powder supply outlet, and a depth width in which the powder supply units drop the powder material to the molding area plane is at least equivalent to the wide edge of the molding area plane; the powder spreading unit includes a scraper or a roller that levels a top surface of the powder material layer, and a depth width in which the powder spreading unit performs surface spreading is at least equivalent to the wide edge of the molding area plane; each jet printing unit includes a jet that includes multiple nozzles arranged in an array and a depth width of a jetting range in which the jet printing units perform binder jet printing is at least equivalent to the wide edge of the molding area plane.

In an embodiment, powder materials in the two powder supply units are different materials; binders in the two jet printing units are different materials.

As described as above, characteristics of the present disclosure include at least: the present disclosure is improvement of a 3D printing apparatus for performing an additive molding method by using powder in cooperation with adhesives; according to the present disclosure, powder supply units, a powder spreading unit, and jet printing units (an adhesive coating system) on two sides thereof are provided on a horizontal moving unit of the jet printing mechanism so that the mechanisms can implement actions of first supplying powder, spreading powder, and then coating adhesives according to requirements in any direction of bidirectional strokes in reciprocating strokes above a molding platform; however, in the prior art, the jet printing apparatus can implement actions of supplying powder, spreading powder, and coating adhesives only in a single direction of strokes, and therefore as compared with the prior art, for example, the past 3DP additive molding technology by using powder in cooperation with binders, the present disclosure has an efficiency at least twice that of the prior art. Moreover, the present disclosure has two independent powder supply grooves and jets, so that compound material jet printing and molding can be effectively implemented.

### BRIEF DESCRIPTION OF THE DRAWINGS

The disclosure will become more fully understood from the detailed description given herein below for illustration only, and thus are not limitative of the disclosure, and wherein:

FIG. 1A is a schematic diagram of a 3DP additive molding technology by using SLS in the prior art;

FIG. 1B is a schematic diagram of a 3DP additive molding technology by using powder in cooperation with binders in the prior art;

FIG. 2 is a 3D schematic diagram of an embodiment of a 3D jet printing apparatus having a reciprocating jetting molding mechanism of the present disclosure;

FIG. 3 is a front view of an embodiment of a 3D jet printing apparatus having a reciprocating jetting molding mechanism of the present disclosure;

FIG. 4 is a front view of an embodiment of movement of a forward stroke of a 3D jet printing apparatus having a reciprocating jetting molding mechanism of the present disclosure;

FIG. 5 is a front view of an embodiment of movement of a reverse stroke of a 3D jet printing apparatus having a reciprocating jetting molding mechanism of the present disclosure; and

FIG. 6 is a bottom view of an embodiment of a jet, which includes multiple nozzles arranged in an array, of a 3D jet printing apparatus having a reciprocating jetting molding mechanism of the present disclosure.

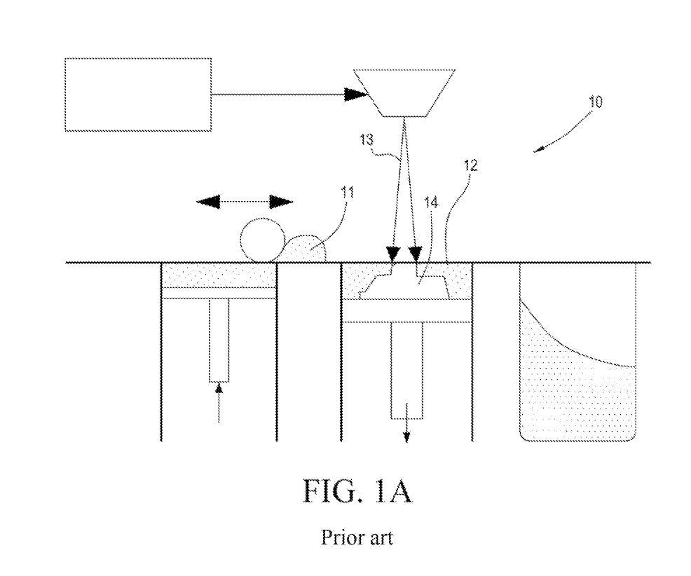

### DETAILED DESCRIPTION

The following describes embodiments of the present invention in detail with reference to the accompanying drawings, and the accompanying drawings are all simplified schematic diagrams, and describe a basic structure of the present invention only in a schematic manner. Therefore, only elements relevant to the present invention are marked, and the displayed elements are not drawn according to the numbers, shapes, and dimension scales in implementation, and the specification and dimension in actual implementation are actually a selective design, and element layout patterns thereof may be more complex.

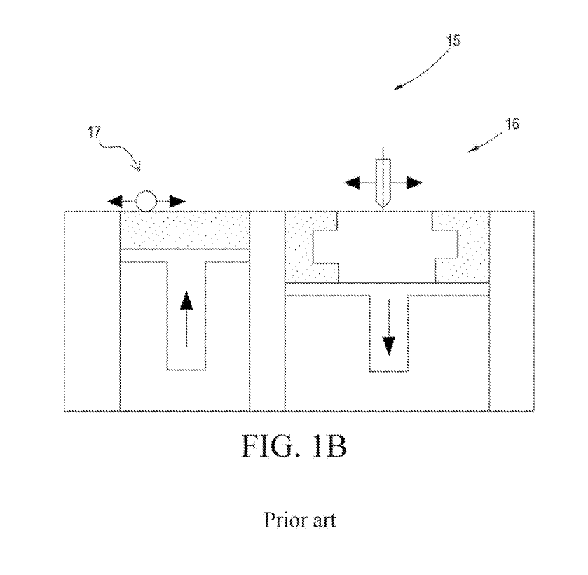

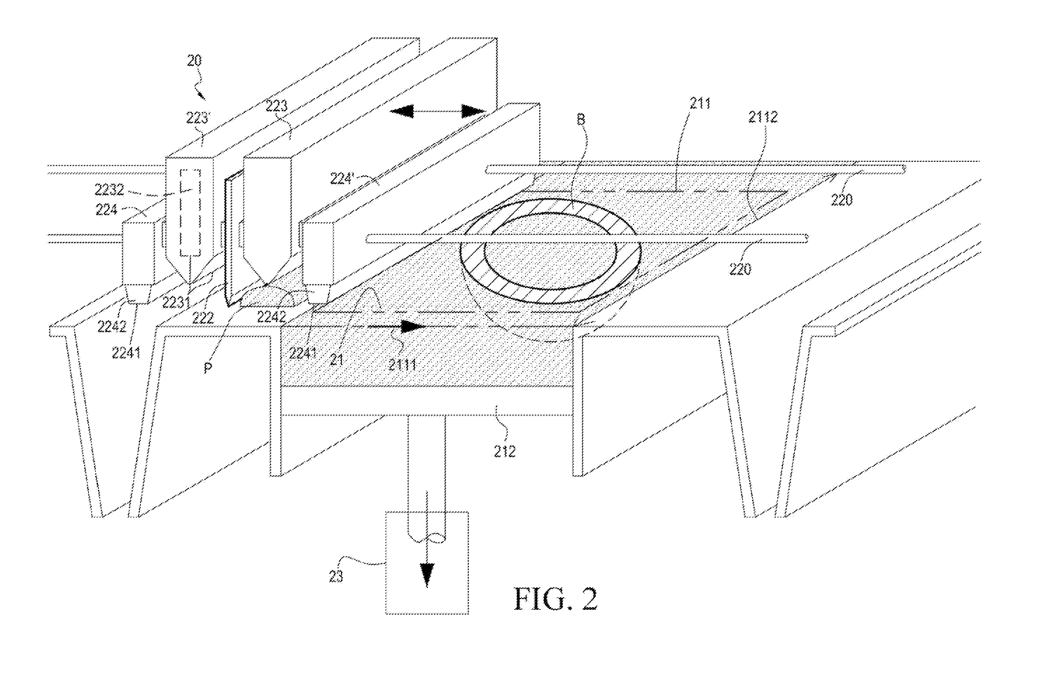

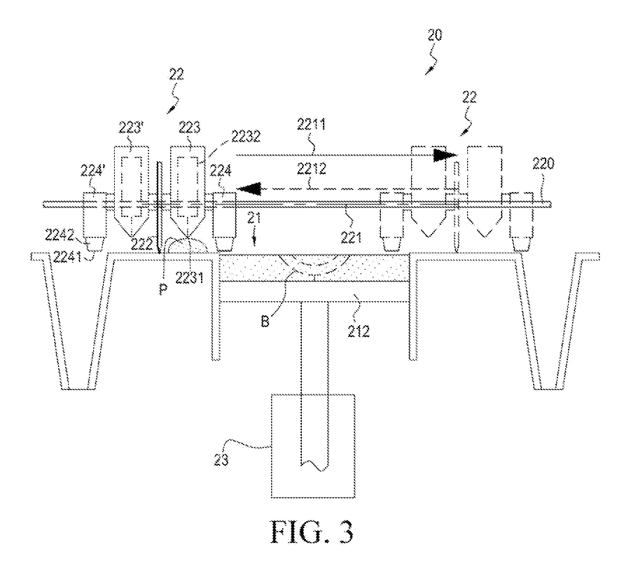

As shown in FIG. 2 and FIG. 3, a structure of a 3D jet printing apparatus 20 having a reciprocating jetting molding mechanism of this embodiment includes: a molding platform mechanism 21, a jet printing mechanism 22, and a vertical lifting mechanism 23. A molding area plane 211 is provided on an upper surface of the molding platform mechanism 21, where the molding area plane 211 is approximately a rectangular area, and has a working direction 2111.

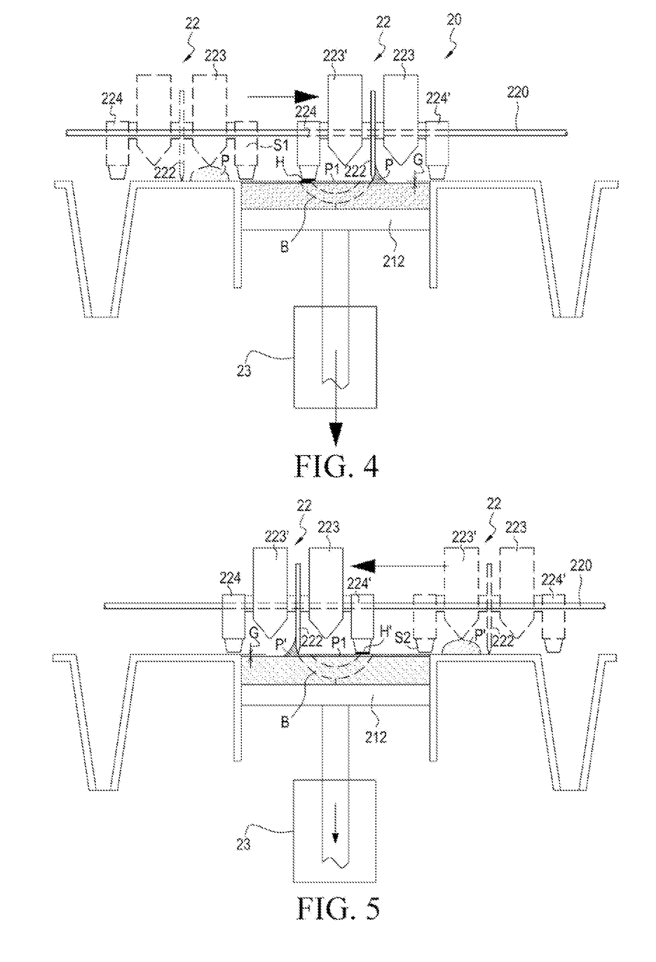

Further refer to FIG. 5. The jet printing mechanism 22 is provided above the molding platform 21, and is enabled, by using a horizontal moving unit 220, to perform reciprocating movement of a forward stroke 2211 and a reverse stroke 2212 along a path 221 parallel to the working direction 2111; the jet printing mechanism 22 includes a powder spreading unit 222, a pair of powder supply units (223,223′) that are separately provided in the working direction 2111 and located on two side surfaces of the powder spreading unit 222, and a pair of jet printing units (224,224′) that are separately provided in the working direction 2111 and are separately located on a side, opposite to the powder spreading unit 222, of the powder spreading unit 222; or in other words, each of the powder supply units (223,223′) is located between the powder spreading unit 222 and any of the jet printing units (224,224′); the powder supply units (223,223′), at a start end (S1,S2) of the forward stroke 2211 or the reverse stroke 2212 performed by the jet printing mechanism 22, can enable the powder supply unit 223 (at the moment, the powder supply unit 223′ on a rear side does not perform an action of supplying powder) that is on a front side along a moving direction of the forward stroke 2212 following the jet printing mechanism 22 drops a powder material P to the molding area plane 211 (this is a first stroke of initial movement; if a last moving stroke is performed previously, the molding area plane 211 herein is on an upper surface, where the powder material P is dropped, of the powder material P′ spread in the last stroke); movement on a same heading direction is continued; the powder spreading unit 222 then touches the powder material P, and spreads flat the powder material P on the molding area plane 211 (or the powder material P′ spread in the last stroke), and forms a powder material layer P1 on the molding area plane 211, and subsequently enables the jet printing 224 that is on a rear side along a moving direction following the jet printing mechanism 22 to perform binder jet printing (at the moment, the jet printing unit 224′ on a relatively front side does not perform movement) on an additive part B of 3D jet printing (namely, one of a local range or an entire range) on the powder material layer P1 that is spread flat corresponding to an upper surface area of the molding area plane 211. A vertical lifting mechanism 23 is connected to the molding platform mechanism 21 or the jet printing mechanism 22; after the jet printing mechanism 22 performs the forward stroke 2211 once or performs the reverse stroke 2212 once, the vertical lifting mechanism 23 adds, between the jet printing mechanism 22 and the molding platform mechanism 21, a distance G that is suitable for stacking and that is vertical to the reciprocating moving direction.

Further, refer to FIG. 5. In this embodiment, the jet printing mechanism 22 horizontally moves along the reverse stroke 2212; at the moment, the powder supply unit 223′ (at the moment, the powder supply unit 223 on a relatively rear side does not perform an action of supplying powder) that is on a relatively front side along a moving direction of the reverse stroke 2212 following the jet printing mechanism 22 drops a powder material P to the molding area plane 211 (this is a first stroke of initial movement; if a last moving stroke is performed previously, the molding area plane 211 herein is on an upper surface, where the powder material P′ is dropped, of the powder material P spread in the last stroke); movement on a same heading direction is continued; the powder spreading unit 222 then touches the powder material P′, and spreads flat the powder material P′ on the molding area plane 211 (or the powder material P spread in the last stroke), and forms a powder material layer P1 on the molding area plane 211, and subsequently enables the jet printing 224′ that is on a rear side along a moving direction following the jet printing mechanism 22 to perform binder jet printing (at the moment, the jet printing unit 224′ on a relatively front side does not perform movement) in a local range or an entire range on the powder material layer P1 that is spread flat corresponding to an upper surface area of the molding area plane 211. Therefore, according to the present disclosure, jet printing can be continuously performed in the interacted forward stroke 2211 and the reverse stroke 2212 of the jet printing mechanism 22, so as to form the 3D object by additive molding, and the production efficiency can be doubled.

In an embodiment, the molding platform mechanism 21 includes a lifting platform 212; the vertical lifting mechanism 23 is connected to the lifting platform 212 and a location of the molding area plane 211 is an upper surface of the lifting platform 212 or an upper surface of the powder material layer P1 that is spread flat on the lifting platform 212.

In another embodiment, the molding area plane 211 includes a wide edge 2112 in a direction vertical to the working direction 2111, and preferably, the wide edge 2112 is a jet printing width of the jet printing mechanism 22; a depth width in which the powder supply units (223,223′) of the jet printing mechanism 22 drop the powder materials (P,P′) to the molding area plane 211 is at least equivalent to the wide edge 2112 of the molding area plane 211; a depth width in which the powder spreading unit 222 performs surface spreading is at least equivalent to the wide edge 2112 of the molding area plane 211, and a depth width of a jetting range in which the jet printing units (224,224′) perform jet printing by using binders (H,H′) is at least equivalent to the wide edge 2112 of the molding area plane 211.

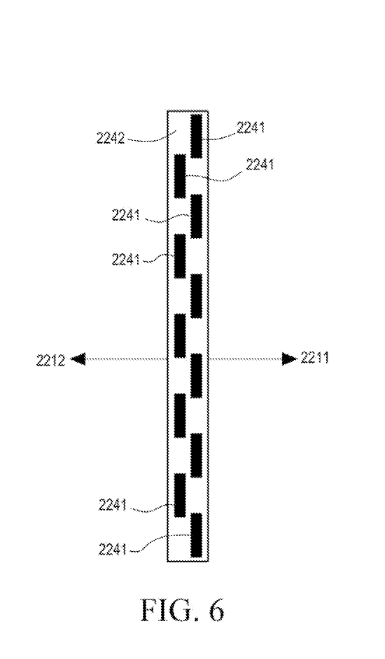

In an embodiment, the powder supply units (223,223′) of the jet printing mechanism 22 include a powder supply outlet 2231 for conveying the powder materials (P,P′) and a powder groove 2232 connected to the powder supply outlet 2231; the powder spreading unit 222 of the jet printing mechanism 22 includes a scraper or a roller that levels a top surface of the powder material layer (P1); each of the jet printing units (224,224′) of the jet printing mechanism 22 includes a jet 2242 that includes multiple nozzles 2241 arranged in an array (a bottom view of the jet 2242 shown in FIG. 6), and the depth width of the jetting range thereof is at least equivalent to the wide edge 2112 of the molding area plane 211.

In another aspect, because the two powder supply units (223,223′) of the jet printing mechanism 22 operate independently, the powder materials (P,P′) in the two powder supply units (223,223′) may be different materials (for example, metal, resin, or casting sand); similarly, the binders (H,H′) in the two jet printing units (224,224′) are different materials; and the foregoing two jet printing units (224,224′) separately store the binders (H,H′) that perform additive molding in cooperation with the powder materials (P,P′) in the powder supply units (223,223′).

According to the foregoing structure, in the present disclosure, when 3D jet printing is performed, the 3D jet printing apparatus receives a Z axis slice of a 3D computer digital file by using a processing unit ((each slice includes an entity part or an non-entity part of the 3D model), and

The foregoing implementation manners or embodiments of the technical means used in the present disclosure are not used to limit an implementation scope of the present invention patent. Equal variations and modifications that accord with literary content of the patent application scope of the present invention or that are made according to the scope of the present invention patent are covered by the scope of the present invention patent.

What is claimed is:

1. A 3D jet printing apparatus having a reciprocating jetting molding mechanism, comprising:
a molding platform mechanism, on an upper surface of which a molding area plane is defined, wherein the molding area plane has a working direction;
a jet printing mechanism, which is provided above the molding platform mechanism and can be enabled to perform reciprocating movement of forward and reverse strokes along a path of the working direction; the jet printing mechanism comprises a powder spreading unit, a pair of jet printing units that are separately provided in the working direction and located on two side surfaces of the powder spreading unit, and a pair of powder supply units that are separately provided in the working direction and located between the powder spreading unit and the jet printing units, wherein the pair of powder supply units can drop a powder material to the molding area plane; the powder spreading unit is configured to spread flat the powder material on the molding area plane to form a powder material layer; and the pair of jet printing units can perform binder jet printing on the powder material layer that is spread flat; and
a vertical lifting mechanism, which is connected to the molding platform mechanism or the jet printing mechanism, and enables the jet printing mechanism and the molding platform mechanism to perform movement in a direction vertical to a vertical reciprocating movement path, so as to change a distance between the jet printing mechanism and the molding platform mechanism.

2. The 3D jet printing apparatus having a reciprocating jetting molding mechanism according to claim 1, wherein the molding platform mechanism comprises a lifting platform; the vertical lifting mechanism is connected to the lifting platform, and a location of the molding area plane is an upper surface of the lifting platform or an upper surface of the powder material layer that is spread flat on the lifting platform.

3. The 3D jet printing apparatus having a reciprocating jetting molding mechanism according to claim 1, wherein the molding area plane comprises a wide edge in a direction vertical to the working direction; a depth width in which the powder supply units of the jet printing mechanism drop the powder material to the molding area plane is at least equivalent to the wide edge of the molding area plane; a depth width in which the powder spreading unit performs surface spreading is at least equivalent to the wide edge of the molding area plane, and a depth width of a jetting range in which the jet printing units perform binder jet printing is at least equivalent to the wide edge of the molding area plane.

4. The 3D jet printing apparatus having a reciprocating jetting molding mechanism according to claim 1, wherein the powder supply units of the jet printing mechanism comprise a powder supply outlet and a powder groove connected to the powder supply outlet.

5. The 3D jet printing apparatus having a reciprocating jetting molding mechanism according to claim 3, wherein the powder supply units of the jet printing mechanism comprise a powder supply outlet and a powder groove connected to the powder supply outlet.

6. The 3D jet printing apparatus having a reciprocating jetting molding mechanism according to claim 1, wherein the powder spreading unit of the jet printing mechanism comprises a scraper or a roller that levels a top surface of the powder material layer.

7. The 3D jet printing apparatus having a reciprocating jetting molding mechanism according to claim 3, wherein the powder spreading unit of the jet printing mechanism comprises a scraper or a roller that levels a top surface of the powder material layer

8. The 3D jet printing apparatus having a reciprocating jetting molding mechanism according to claim 1, wherein each jet printing unit of the jet printing mechanism comprises a jet that comprises multiple nozzles arranged in an array.

9. The 3D jet printing apparatus having a reciprocating jetting molding mechanism according to claim 3, wherein each jet printing unit of the jet printing mechanism comprises a jet that comprises multiple nozzles arranged in an array.

10. The 3D jet printing apparatus having a reciprocating jetting molding mechanism according to claim 1, wherein powder materials in the two powder supply units of the jet printing mechanism are different materials.

11. The 3D jet printing apparatus having a reciprocating jetting molding mechanism according to claim 3, wherein powder materials in the two powder supply units of the jet printing mechanism are different materials.

12. The 3D jet printing apparatus having a reciprocating jetting molding mechanism according to claim 1, wherein binders in the two jet printing units of the jet printing mechanism are different materials.

13. The 3D jet printing apparatus having a reciprocating jetting molding mechanism according to claim 6, wherein binders in the two jet printing units of the jet printing mechanism are different materials.

14. The 3D jet printing apparatus having a reciprocating jetting molding mechanism according to claim 6, wherein the two jet printing units of the jet printing mechanism separately store the binders that perform additive molding in cooperation with the powder materials in the powder supply units.

15. The 3D jet printing apparatus having a reciprocating jetting molding mechanism according to claim 1, wherein an area in which the jet printing units perform binder jet printing is an entity part of a 3D model of a slice layer corresponding to a 3D computer model digital file linked to the jet printing apparatus.
